(19) United States
(12) Patent Application Publication
(10) Pub. No.: US 2012/0205926 A1
(43) Pub. Date: Aug. 16, 2012

(54) Door Wedge Operated by Lock

(76) Inventor: Thomas Guiboche, Winnipeg (CA)

(21) Appl. No.: 13/349,637

(22) Filed: Jan. 13, 2012

Related U.S. Application Data
(60) Provisional application No. 61/443,539, filed on Feb. 16, 2011.

(51) Int. Cl. E05C 17/44

(52) U.S. Cl. 292/338

(57) ABSTRACT

Apparatus for wedging a door against forced opening is operated by rotation of the interior actuation lever of a dead bolt to raise and lower a wedging leg. A bracket is attached to the door at the dead bolt and releasably attaches to a housing on which the leg is mounted for pivotal movement between the raised inoperative position and a lowered wedging position. An operator at the housing is moved downwardly by rotation of the lock lever to the open position to pull on a spring which is connected to an upper end of the leg which causes lifting of the leg to the raised position.

This application claims the benefit under 35 USC 119 (e) of Provisional Application 61/443539 filed Feb. 16 2011.

This application relates to an apparatus for wedging a door against forced opening where the door has a dead bolt operable by a key externally and by a lever internally to move between locked and unlocked positions.

According to the invention there is provided an apparatus for wedging a door against forced opening, the door having a dead bolt operable by a key externally and by a lever internally to move between locked and unlocked positions, the apparatus comprising:

a base member for engaging the floor inside the door;

a leg extending from the base member to the door handle;

a bracket for attachment to the door at the deadbolt lock;

a housing releasably attachable to the bracket;

the leg being pivotally mounted on the housing so as to be movable between a raised position in which the base member is free from the floor to allow free opening of the door and a lowered position in which the base member engages the floor;

and an operator arranged to engage the lever so that movement of the lever to the locked position causes the leg to be held in the lowered position and so that movement of the lever to the un-locked position causes lifting of the leg to the raised position.

Preferably the base member is a pivotal foot pad for frictionally engaging the floor.

Preferably the leg is extendable by an adjustment system including a spring pin and series of holes.

Preferably the operator is movable on the housing relative to the leg.

Preferably the operator includes an abutment member standing upwardly from the leg

Preferably the abutment member has a top flange extending outwardly from the door for engaging the lock lever.

Preferably the bracket is arranged for permanent attachment to the door at the dead bolt and carries releasable attachment members for connection to the housing.

Preferably the attachment members include a horizontal sliding action to engage.

Preferably the leg includes a spring for biasing the spring to the raised position to counter the weight of the leg and base member.

Preferably the leg is separable into two parts including an upper part for engaging the housing and a lower part and wherein there is provided a bifurcated engagement member defining a pair of legs for engaging under the door handle so that the lower part of the leg can be used with the member with the bracket removed.

### BRIEF DESCRIPTION OF THE DRAWINGS

One embodiment of the invention will now be described in conjunction with the accompanying drawings in which:

FIG. 1 is a side elevational view of an apparatus according to the present invention.

FIG. 2 is a front elevational view of the upper end of the leg and bracket and housing of FIG. 1.

FIG. 3 is a side elevational view of the upper end of the leg and bracket and housing of FIG. 1.

FIG. 4 is a cross-sectional view of the upper end of the leg and housing of FIG. 1.

FIG. 4A is a cross-sectional view of the upper end of the leg and housing of FIG. 1.

FIG. 5 is a front elevational view of the bracket of FIG. 1.

FIG. 6 is a side elevational view of the bracket of FIG. 1.

FIG. 7 is a side elevational view of the leg of FIG. 1. and a replacement member for use with the leg.

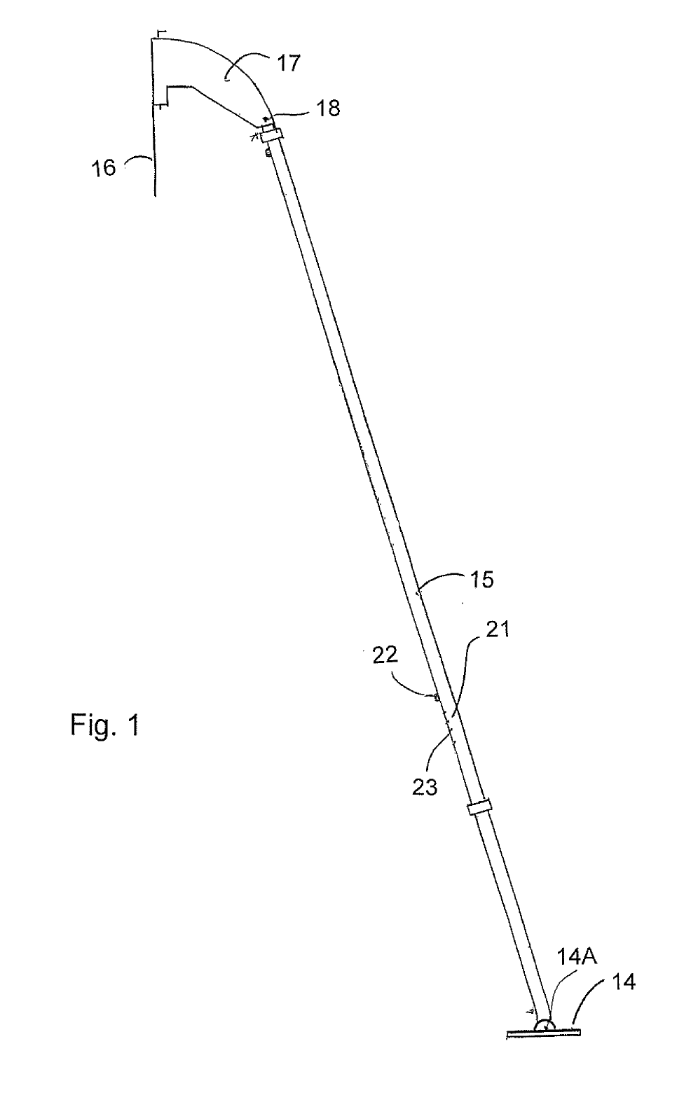

In the drawings like characters of reference indicate corresponding parts in the different figures.

### DETAILED DESCRIPTION

A door 10 has a conventional dead bolt 11 mounted by screws on the door 13 and operable by a key externally (not shown) and by a lever 12 internally to move a bolt between locked and unlocked positions transversely of the lever 12 to engage into a receptacle on the door frame. As these are conventional components well known to persons skilled in this art and widely available from different manufacturers, the details are not shown herein.

The apparatus for wedging the door against forced opening, includes a base member 14 in the form of a pad pivotal on a pin 14A for engaging the floor inside the door. A leg 15 extends from the base member to a position adjacent dead bolt 11 at the door handle so that when in position between the deadbolt and the floor, the leg acts as a wedge to inhibit opening of the door by transferring a pushing force onto the door into frictional engagement with the floor.

A bracket 16 is attached to the door at the deadbolt lock by clamping an annular plate 16A behind an edge of a circular lock plate 11A of the dead bolt 11. The bracket 16 includes the plate 16A attached to a ring 16B and a depending rectangular plate 16C which lies in a common front plane of the door underneath the dead bolt 11. A housing 17 is releasable attachable to the bracket 16 by sliding horizontally projections 16D of the bracket on the plate 16C which engage into slots 17A on the housing 17.

The leg 15 is pivotally mounted on the housing 17 at a pivot pin 18 and includes an upper portion 15A which extends from the pivot pin 18 through a depending channel portion 17C the housing to an upper end 15B at the bracket 16. The leg 15 is movable between a raised position in which the base member is lifted from the floor to allow free opening of the door and a lowered position in which the base member engages the floor in the frictional wedging action.

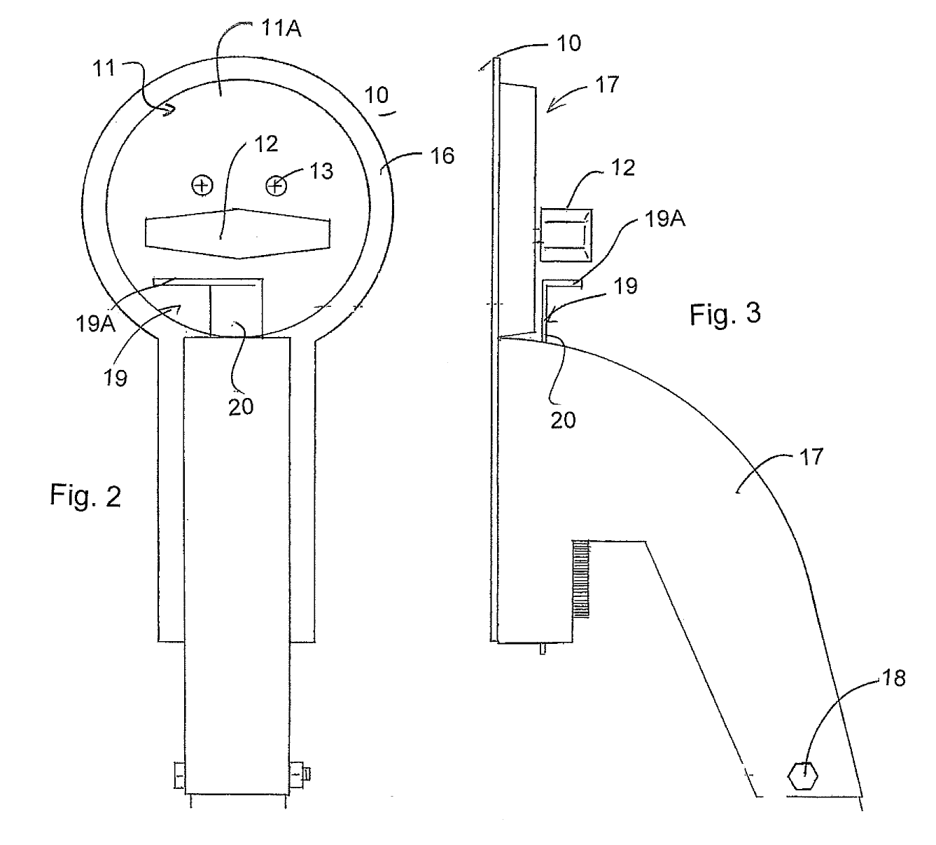

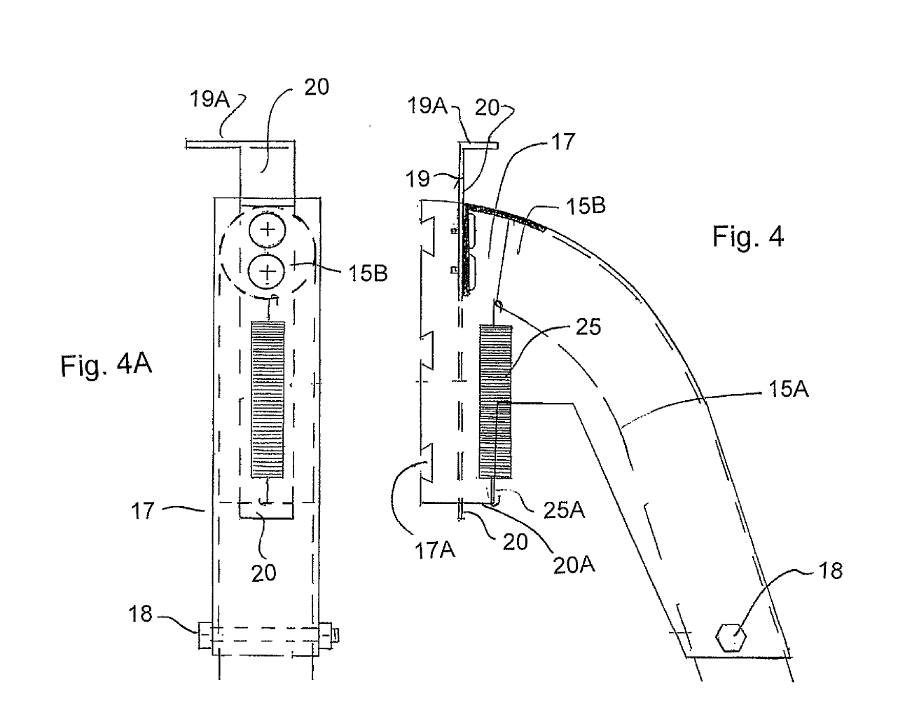

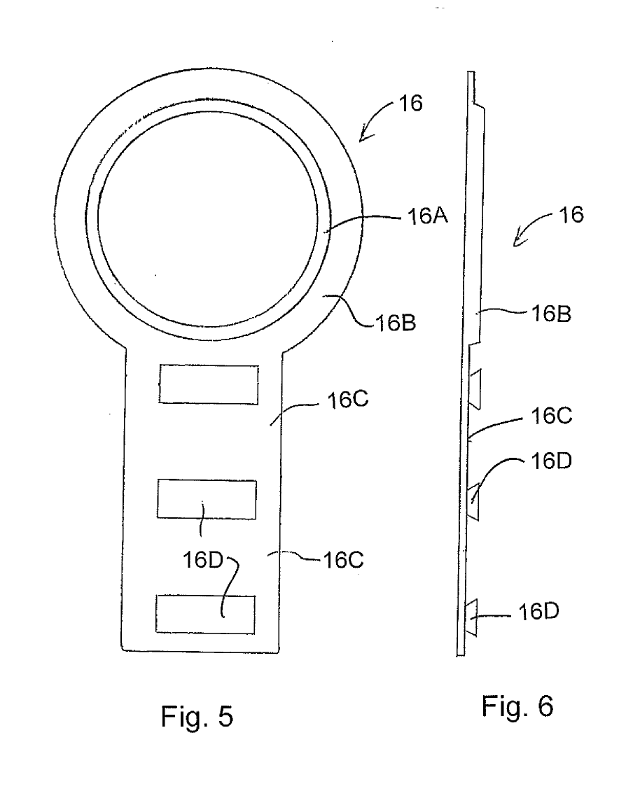

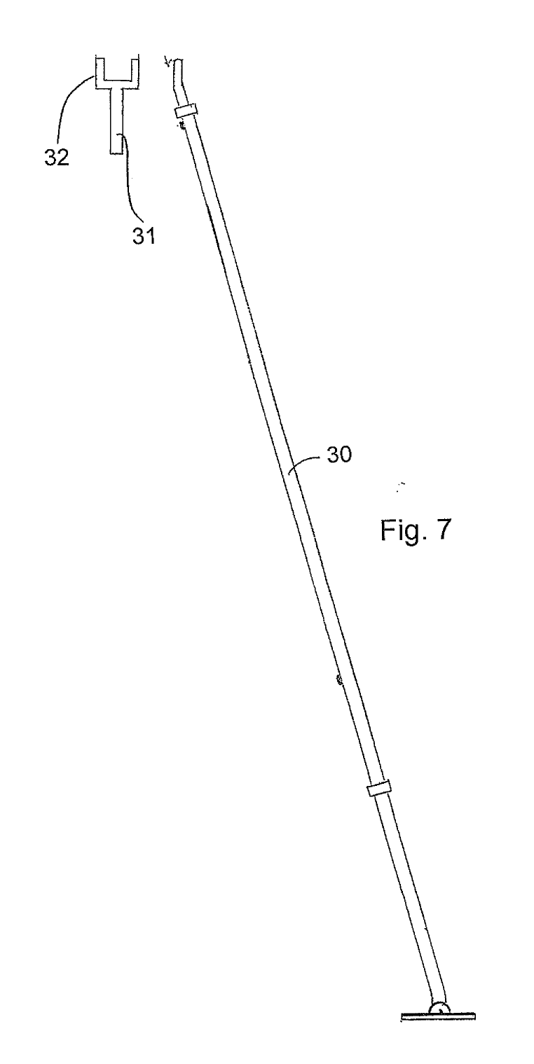

An operator 19 includes a top plate 19A is arranged to engage the lever 12 so that movement of the lever to the locked position (shown in FIGS. 2 and 3) where the lever 12 is horizontal and thus spaced from the plate 19A causes the leg to be held in the lowered position by its weight applied around the pivot pin 18. Movement of the lever 12 to the un-locked position where the lever 12 is vertical and thus presses down on the plate 19A causes pressure to be applied on a vertical flange 20 of the actuator 19 which carries a bottom hook portion 20A which pulls down on a bottom end 25A of a spring 25. A top end 25B of the spring 25 is attached to the top end 15B of the leg 15 so as to pull down on the upper end 15B acting to apply a force on the leg tending to pivot the leg 15 about the pin 18. This acts to cause lifting of the leg 15 to the raised position.

The leg is extendable by an adjustment system 21 including a spring pin 22 and series of holes 23.

The operator includes an abutment member 19 standing upwardly from the leg with the top flange 19A extending outwardly from the door for engaging the lock lever 13.

The bracket is arranged for permanent attachment to the door at the dead bolt by clamping between the door and the deadbolt plate and carries releasable attachment members defined by the projections 16D and the slots 17A for connection to the housing.

The leg includes a spring 25 connected between the leg and the housing for biasing the leg to the raised position to counter the weight of the leg and base member.

As shown in FIG. 7 the leg is separable into two parts including the upper part for engaging the housing and a lower part 30. A bifurcated engagement member 31 defines a pair of legs 32 for engaging under the door handle so that the lower part 30 of the leg can be used with the member with the bracket removed in a separate operation where the bracket is not suitable or where the device is used with a door which does not have a dead bolt.

In operation the bracket 16 attaches to the deadbolt and the housing 17 snaps onto the bracket 16. When the key turns the deadbolt 12 to open the door this action also pushes down on the operator 19. With the help of flange 20 and spring 25 they both pull down on the upper end of the leg. This combined action lifts up the security leg so the door can open. When the door closes and the deadbolt again locks the door the operator 19 lifts upwardly under the weight of the leg 15 and the security leg comes back down giving the door added reinforcement and added door security from crimes such as home break-ins and home invasions. The smame leg arrangement can be used by replacing the upper end at housing 17 with the adapter of FIG. 7 that fits under the door knob of any bathroom or bedroom door for added privacy and security.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. Apparatus for wedging a door against forced opening, the door having a dead bolt operable by a key externally and by a lever internally to move between locked and unlocked positions, the apparatus comprising:
a base member for engaging the floor inside the door;
a leg extending from the base member to the door handle;
a bracket for attachment to the door at the deadbolt lock;
a housing releasable attachable to the bracket;
the leg being pivotally mounted on the housing so as to be movable between a raised position in which the base member is free from the floor to allow free opening of the door and a lowered position in which the base member engages the floor;
and an operator arranged to engage the lever so that movement of the lever to the locked position causes the leg to be held in the lowered position and so that movement of the lever to the un-locked position causes lifting of the leg to the raised position.

2. The apparatus according to claim 1 wherein the base member is a pivotal foot pad for frictionally engaging the floor.

3. The apparatus according to claim 1 wherein the leg is extendable by an adjustment system including a spring pin and series of holes.

4. The apparatus according to claim 1 wherein the operator is movable on the housing relative to the leg.

5. The apparatus according to claim 1 wherein the operator includes an abutment member standing upwardly from the leg

6. The apparatus according to claim 1 wherein the abutment member has a top flange extending outwardly from the door for engaging the lock lever.

7. The apparatus according to claim 1 wherein the bracket is arranged for permanent attachment to the door at the dead bolt and carries releasable attachment members for connection to the housing.

8. The apparatus according to claim 1 wherein the attachment members include a horizontal sliding action to engage.

9. The apparatus according to claim 1 wherein there is provided a spring for biasing the leg to the raised position to counter the weight of the leg and base member, the spring being attached to the operator such that rotation of the door lock lever acts to tension the spring to pivot the leg to the raised position.

10. The apparatus according to claim 1 wherein the operator is arranged to be pushed downwardly by the rotation of the door lock lever so as to pull downwardly on a lower end of the spring with an upper end of the spring pulling downwardly on an upper end of the leg to pivot the leg about a transverse pivot axis to the raised position.

11. The apparatus according to claim 1 wherein the leg is separable into two parts including an upper part for engaging the housing and a lower part and wherein there is provided a bifurcated engagement member defining a pair of legs for engaging under the door handle so that the lower part of the leg can be used with the member with the bracket removed.
